(19) United States
(12) Patent Application Publication
(10) Pub. No.: US 2008/0200593 A1
(43) Pub. Date: Aug. 21, 2008

(54) Functional Adhesive, Construction Material Using the Same, and Method For Preparing the Adhesive

(75) Inventors: Sung-Hoon Yue, Kyungki-do (KR); Il-Hong Min, Chungcheongbuk-do (KR); Seog-Goo Kang, Chungcheongbuk-do (KR); Jae-Youl Joung, Chungcheongbuk-do (KR); Min-Jung Lee, Chungcheongbuk-do (KR)

Correspondence Address: CANTOR COLBURN, LLP, 20 Church Street, 22nd Floor, Hartford, CT, 06103, US

(73) Assignee: LG TWIN TOWERS 20, Seoul (KR)

(21) Appl. No.: 11/912,275

(22) PCT Filed: Apr. 20, 2006
(86) PCT No.: PCT/KR2006/001481

§ 371 Date: Oct. 22, 2007

(30) Foreign Application Priority Data
Apr. 22, 2005 (KR) 10-2005-0033372
Apr. 18, 2006 (KR) 10-2006-0035070

(51) Int. Cl. C08L 3/04; C08L 31/04; C08G 18/00; C08L 83/00

(52) U.S. Cl. 524/53; 524/563; 524/612; 524/589; 524/588

(57) ABSTRACT

Provided is a functional adhesive including or a mixture thereof, wherein the flavonoid-based compound, the polyphenol-based compound, or the steroid-based compound has a molecular weight of 250 to 1000. The functional adhesive has a low concentration of VOCs and HCHO, and also facilitates a low concentration of VOCs in products to which the functional adhesive is applied.

### TECHNICAL FIELD

The present invention relates to a functional adhesive, a construction material using the same, and a method of preparing the functional adhesive, and more particularly, to an environment-friendly functional adhesive having low volatile organic compounds (VOC) content and not having formaldehyde (HCHO) by using dried powders of natural plants, etc., and thus being capable of improving residential quality by minimizing diffusion of hazardous compounds, a construction material using the functional adhesive and a method of preparing the functional adhesive.

### BACKGROUND ART

Among various pollutants affecting indoor air, VOCs and HCHO influence the respiratory organs, the circulatory organs, and even the nerve system in human bodies, and thus the ability to sense with the peripheral nervous system is decreased as shown in Table 1, in which types of VOCs generated indoors and the effects of VOCs on the human body are shown, and Table 2, in which harmful effects of HCHO are shown. The use of VOCs and HCHO has been restricted in Korea, the United States, Japan and Europe due to their carcinogenesis and toxicity.

In particular, after the bill regarding indoor air quality was passed in 2004, Total Volatile Organic Compounds (TVOC) and HCHO, which are criteria for harmfulness to the human body have been a major issue.

TABLE 1

| Pollutant | Effect on the human body |
|---|---|
| volatile Organic Compound | difficulty in breathing, drowsiness, |
| (benzene, toluene, xylene, styrene, | coma, headache, dizziness, fatigue, |
| benzaldehyde, etc.) | unconsciousness, etc. |

TABLE 2

| Concentration (ppm) | Effect on the human body |
|---|---|
| 0.1 to 5 | stimulus to eyes, causing tears, stimulus to the |
| | upper airway |
| 1 or less | stimulus to eyes, nose, throat |
| 0.25 to 5 | serious asthma attacks in asthma patients |
| 10 to 20 | coughing, lung tightness, heavy feeling in the head, |
| | quickened heartbeat |
| 50 to 100 | Accumulation of body fluid in lungs, lung |
| | inflammation, death, when drinking through mouth, |
| | vomiting, diarrhea, dizziness, excruciating pain in |
| | mouth, throat and stomach, convulsions, coma |

To improve the quality of indoor air, a paint prepared by mixing a photocatalyst such as TiO₂, an inorganic material such as tormaline, an anion, and ZnO—MnO₂ with a synthetic resin has been used. A air conditioning system within residences and commercial buildings has also been tried to improve the quality of indoor air. However, costs for such systems are too high and the effect thereof has not been proved.

The efficiency of such materials in decomposing or adsorbing VOCs and HCHO decreases over time, and reactions in the decomposing or adsorbing the pollutants are limited since such materials are inorganic or synthetic materials.

Meanwhile, flavonoid-based compounds, polyphenol-based compounds, and steroid-based compounds obtained from natural sources are known to be effective for deodorization, detoxifying heavy metals and nicotine, cancer prevention, endocrine disrupter suppression, anti-oxidation, nitrate decomposition, and disinfection of catechin, and such compounds are now used in beverage, cosmetic, and food products.

These compounds are organic compounds capable of bonding with VOCs and the like via chemical reactions, thereby having an excellent ability to decompose or adsorb pollutants.

Thus, the development of a functional adhesive having the properties of these compounds is required.

### DETAILED DESCRIPTION OF THE INVENTION

### Technical Problem

The present invention provides an environmentally friendly functional adhesive having excellent storage stability and long pot life that allows only a small amount of volatile organic compounds (VOCs) and formaldehyde (HCHO) to diffuse therefrom and from products containing the functional adhesive.

The present invention also provides a construction material to which the functional adhesive is applied.

The present invention also provides a method of preparing the functional adhesive.

### Technical Solution

According to an aspect of the present invention, there is provided a functional adhesive including a flavonoid-based compound, a polyphenol-based compound, a steroid-based compound or a mixture thereof, wherein the flavonoid-based compound, the polyphenol-based compound, or the steroid-based compound has a molecular weight of 250 to 1000.

In an embodiment of the present invention, the flavonoid-based compound or the polyphenol-based compound may include at least one compound of anthoxanthin, anthocyanin, catechin, tannin, and caffeine.

The steroid-based compound may include at least one compound of cholesterol, saponin, and β-carotene.

The amount of the flavonoid-based compound, the polyphenol-based compound or the steroid-based compound may be in the range of 0.5 to 2% by weight based on the total amount of the functional adhesive.

The flavonoid-based compound or the steroid-based compound may be obtained from natural plants.

Examples of the natural plant may include at least one plant of an oak tree, a mangrove tree, a mahogany tree, an acacia tree, a persimmon tree, a chestnut shell, a peach, an apple, a grape, a persimmon, green tea, black tea, oolong tea, jasmine tea, bohea tea, tieguanyin tea, Bongro tea, Youbi tea, Soosun tea, Ogo tea, white tea, blue tea, powdered green tea, cassia tea, tobacco leaf, angelica keiskei, kale, coffee, and barley.

The flavonoid-based compound, the polyphenol-based compound or the steroid-based compound may be provided in the form of dried powder, a suspension of a dried powder, flakes, an extract, or a dried powder of the extract of the natural plant.

The particle size of the dried powder and the thickness of the flakes of the natural plant may be in the range of 20 to 150 μm.

The amount of the dried powder or the flake of the natural plant may be in the range of 1 to 10% by weight based on the total amount of the functional adhesive.

The solvent used for the extract and the suspension of the dried powder of the natural plant may include at least one solvent of water, alcohol, oil, and resin.

The functional adhesive includes main components and additives. The main components may include at least one resin of a polyvinylacetate-based resin, an ethylenevinylacetate-based resin, a melamin-based resin, urea-based resin, a phenol-based resin, a urethane-based resin, an epoxy-based resin, an acryl-based resin, a silica-based resin, and a hardener. The additives may include at least one of a filler, a stabilizer, an anti-foaming agent, a dispersing agent, and flatting agent.

The main components may include 90% by weight of a polyvinylacetate-based resin and 10% by weight of an isocyanate-based hardener (MDI). The filler is flour. The flavonoid-based compound, the polyphenol-based compound, the steroid-based compound or the mixture thereof may be a green tea leaf powder. The amount of the main components may be 81.8 to 96.8% by weight, the amount of the flour may be 0.7 to 8.2% by weight, and the amount of the green tea leaf powder may be 2.5 to 10% by weight.

The functional adhesive may be used to provide an adhesive force to the surface of at least one construction material of a film, a door, a window, a chair, a desk, a floor, wall paper, a construction material for a ceiling, a construction material for a closet and a flooring material.

According to another aspect of the present invention, there is provided a construction material to which the functional adhesive is applied.

According to another aspect of the present invention, there is provided a method of preparing a functional adhesive including: grinding a dried plant and selecting a micropowder having a particle size of 20 to 150 μm; reacting and melting adhesive raw materials including main component resins by heating; sufficiently mixing the micropowder with a filler; and dispersing the mixed powder in the adhesive raw materials such that the amount of the mixed powder is 1 to 10% by weight based on the total amount of the functional adhesive.

In the method of preparing the functional adhesive, a natural plant extract, a dried powder of an extract of a natural plant or a suspension of the micropowder may be added to the functional adhesive raw materials instead of the micropowder.

In the method of preparing the functional adhesive, the natural plant may include at least one plant of an oak tree, a mangrove tree, a mahogany tree, an acacia tree, a persimmon tree, a chestnut shell, a peach, an apple, a grape, a persimmon, green tea, black tea, oolong tea, jasmine tea, bohea tea, tieguanyin tea, Bongro tea, Youbi tea, Soosun tea, Ogo tea, white tea, blue tea, powdered green tea leaf, cassia tea, tobacco leaf, angelica keiskei, kale, coffee, and barley.

Thus, the functional adhesive of the present invention includes natural compounds having an adsorbing capability and has a low concentration of VOCs and HCHO.

### DESCRIPTION OF THE DRAWINGS

The above and other features and advantages of the present invention will become more apparent by describing in detail exemplary embodiment thereof with reference to the attached drawing in which:

FIG. 1 is a flowchart illustrating a method of preparing a functional adhesive including a dried powder or flakes of natural plants according to an embodiment of the present invention.

### BEST MODE

The present invention will now be described in more detail.

In the present disclosure, the term “adhesive” indicates a substance such as glue, used to make things stick together. The adhesive may be a one-component adhesive or a two-component adhesive. In the one-component adhesive, the main components and additives are mixed and dispersed as one product, while in the two-component adhesive, the main components and the additives are independently packaged and mixed when used. The functional adhesive according to an embodiment of the present invention can be a one-component or two-component adhesive.

The functional adhesive of the present embodiment includes a flavonoid-based compound, a polyphenol-based compound, a steroid-based compound or a mixture thereof, wherein each compound has a molecular weight of from 250 to 1000.

The flavonoid-based compound, derived from the Greek term flavus meaning a yellow color, is a yellowish-orange pigment widely found in plants, and includes flavone as a basic structure. The flavonoid-based compound is found in high concentrations in all parts of plant such as leaves, flowers, roots, fruits and stems, but is found in relatively low concentration in animals.

The polyphenol-based compound is an aromatic compound such as benzene having at least one hydroxyl group, and is found in various plants that are sour and bitter. The pharmacological functions such as antibiotic, anti-inflammatory, skin soothing, cholesterol lowering and anti-allergenic functions of the polyphenol-based compound are well known.

The steroid-based compound having a steroid nucleus is generally found in hormones, etc. and has various structures according to substituents, and is found in plants.

Among these compounds, those having a molecular weight of 250 to 1000 are suitable for embodiments of the present invention. When the molecular weight is less than 250, the volatility of the compound is too high. When the molecular weight is greater than 1000, the compound forms an oligomer, thereby increasing the viscosity of the functional adhesive or relatively decreasing the organic material-adsorbing capability of the functional adhesive.

The flavonoid-based compound and the polyphenol-based compound according to an embodiment of the present invention may be anthoxanthin, anthocyanin, catechin, and tannin, and more preferably, catechin and tannin, but are not limited thereto.

Catechin can have a structure of (−)-catechin as illustrated in formula 1 below, or (+)-catechin as illustrated in formula 2 below according to its stereostructure. Many derivatives of catechin based on these structures are well known in the art.

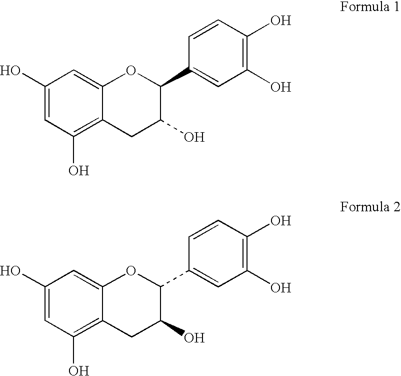

Additionally, catechin is known to be a functional compound having various pharmacological effects.

The steroid-based compound according to an embodiment of the present invention may be cholesterol or saponin, and more preferably saponin, but is not limited thereto.

Saponin has a structure including a steroid nucleus (aglycone) with saccharide moieties. For example, the structure of the saponin may be one of those shown in formulae 3 and 4 below. Examples of the saccharide include D-glucose, D-galactose, L-arabinose, D-rhamnose, etc.

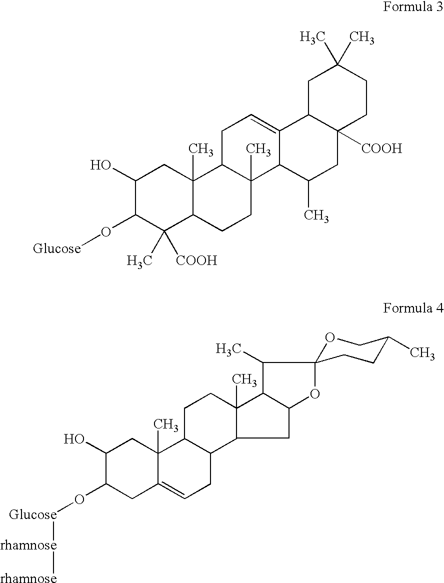

The amount of the flavonoid-based compound, polyphenol-based compound, or steroid-based compound may be in the range of 0.5 to 2% by weight based on the total amount of the functional adhesive. When the amount is less than 0.5% by weight, VOCs and the like cannot be sufficiently adsorbed. On the other hand, when the amount is greater than 2% by weight, the effects are not noticeable and the innate color of the compound may influence the overall color of the adhesive.

Meanwhile, the amount of the flavonoid-based compound, the polyphenol-based compound or the steroid-based compound may be in the range of 0.01 to 2% by weight based on the total amount of the adhesive. When the amount of the compound is in the range of 0.5 to 2% by weight, the ability to adsorb VOCs and the like noticeably increase.

The flavonoid-based compound, the polyphenol-based compound, or the steroid-based compound according to an embodiment of the present invention may be obtained from natural plants. Examples of the natural plants include oak trees, mangrove trees, mahogany trees, acacia trees, persimmon trees, chestnut shells, peaches, apples, grapes, persimmons, green tea, black tea, oolong tea, jasmine tea, bohea tea, tieguanyin tea, Bongro tea, Youbi tea, Soosun tea, Ogo tea, white tea, blue tea, powdered green tea, cassia tea, tobacco leaves, angelica keiskei, kale, coffee, and barley, but are not limited thereto. The flavonoid-based compound, the polyphenol-based compound or the steroid-based compound is provided in the form of a dried powder, a suspension of a dried powder, flakes, an extract, or a dried powder of the extract, but is not limited thereto.

The present invention will now be described in more detail with reference to green tea leaves, which are one of the natural plants applied to the functional adhesive according to an embodiment of the present invention.

Green tea leaves contain 10 to 20% catechin, 0.6 to 0.7% flavonoid, 2 to 4% caffeine, 0.6% polysaccharide, 150 to 250 mg % of vitamin C, 25 to 70 mg % of vitamin E, 13 to 29 mg % of β-carotene, 100 to 200 mg % of γ-aminobutyric acid (GABA), saponin, 90 to 350 ppm fluorine, 35 to 75 ppm zinc, and 1.0 to 1.8 ppm selenium as main components. Catechin, which constitutes the largest portion of green tea leaves, contains a lot of a hydroxyl group, and thus easily bonds with VOCs and stabilizes them. Thus, catechin can remove activated oxygen in bodies, promote the oxidation of fat together with vitamins, and adsorb HCHO at ortho- and para- sites of a polyphenol group. Most of the reactions that occur in polyphenol groups are exthothermic reactions, and thus the reactions cause very strong bonds. Therefore, the exthothermically bonded compound is hardly released after the reaction finishes. Saponin forms slightly soluble compounds by bonding with stearin, alcohol, phenol, etc. Green tea leaves catch VOCs and HCHO in human bodies using such mechanisms.

In an embodiment of the present invention, a green tea leaf powder or an extract from green tea leaves is a liquid extract prepared using water and organic solvents such as alcohol, etc. Total volatile organic compounds (TVOC) include all VOCs detected between hexane and hexadecane during the GC/MS analysis under ISO 6000-3 and ISO 6000-6.

The particle size of the dried powder and the thickness of a flake of the natural plant in an embodiment of the present invention may be in the range of 20 to 150 μm. When the particle size or thickness is less than 20 μm, the dried power or the flake cannot be easily mixed with the functional adhesive raw materials due to dust. On the other hand, when the particle size or thickness is greater than 150 μm, the dried powder or the flake cannot be uniformly dispersed in the functional adhesive. The amount of the dried powder or the flake of the natural plant may be in the range of 1 to 10% by weight based on the total amount of the functional adhesive. Also, the amount of the extract or the liquid containing the dried powder of the extract dissolved or dispersed in a solvent may also be in the range of 1 to 10% by weight based on the total amount of the functional adhesive. When the amount is less than 1% by weight, the amount of the effective components is too small to obtain the desired effect. When the amount is greater than 10% by weight, the effect is not noticeably increased. Therefore, the amount of the flavonoid-based compound, the polyphenol-based compound, or the steroid-based compound may be in the range of 0.01 to 2% by weight based on the total amount of the functional adhesive, and more preferably, 0.5 to 2% by weight.

The solvent used for the extract or the suspension of the dried powder of the natural plant in an embodiment of the present invention may be any solvent generally used for extracts of organic substances for example, water, such as tap water, distilled water, or ultra pure water; alcohol, such as methanol, ethanol, propanol, butanol, isopropyl alcohol, or hexanol; an oil, such as inseed oil, wood oil, or dry oil like perilla oil; or a resin such as acryl-based resin, epoxy-based resin, urethane-based resin, ester-based resin, silica-based resin, melamine-based resin, phenol-based resin, urea-based resin, or the like.

The main components of the functional adhesive may be composed of 90% by weight of a polyvinylacetate-based resin and 10% by weight of a isocyanate-based hardener (MDI), a filler is flour, and the flavonoid-based compound, the polyphenol-based compound, the steroid-based compound or the mixture thereof is included in green tea leaf powder. The functional adhesive may include 81.8 to 96.8% by weight of the main components, 0.7 to 8.2% by weight of the flour, and 2.5 to 10% by weight of the green tea leaf powder.

The functional adhesive can be used to provide an adhesive force to the surface of furniture or construction materials such as a door, a window, a chair, a desk, a floor, wall paper, flooring material, material for a ceiling, and material for closet; interior and exterior materials of automobiles; and home appliances such as a television, a refrigerator, etc., but the use of the functional adhesive is not limited thereto.

In an embodiment of the present invention, a construction material to which the functional adhesive is applied may be a material for a ceiling, a material for a closet, or a flooring material, and more preferably, an ondol floor (Korean sub-floor heating system), a flooring covering or tiles.

The functional adhesive including green tea components can improve the quality of the air in confined indoor spaces and basement spaces, and minimize VOCs and HCHO diffusion when used as a functional adhesive for a material for a ceiling, a material for a wall and a flooring material.

A method of preparing the functional adhesive according to an embodiment of the present invention will now be described in more detail.

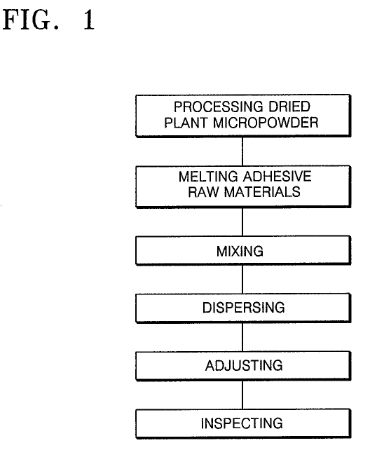

The method includes: grinding a dried plant and selecting a micropowder having a particle size of 20 to 150 μm; reacting and melting adhesive raw materials including the main component resins by heating; sufficiently mixing the powder of the natural plant with the filler; and dispersing the mixed powder in the adhesive raw materials such that the functional adhesive contains 1-10% by weight of the mixed powder. FIG. 1 is a flowchart illustrating a method of preparing a functional adhesive including a dried powder or flakes of natural plants according to an embodiment of the present invention. The method includes a process of grinding and selecting, a process of melting, a process of mixing, a process of dispersing, a process of adjusting, and a process of inspection.

In the process of grinding and selecting, green tea leaves and stems are grinded by a grinder with strong rotary power. When the grinding is completed, the particles discharged from the grinder are classified according to particle size using air from an air blower and micropowders having a particle size of 20 to 150 μm are selected and used.

A natural plant extract, a dried powder of an extract of a natural plant or a suspension of the micropowder may be added to the functional adhesive raw materials instead of the micropowder. That is, the micropowder may be added to the adhesive raw materials, the liquid extract extracted using an organic solvent may be added to the adhesive raw materials, or a liquid in which the powder is dissolved and dispersed may be added to the adhesive raw materials.

The process of heating is a batch process in which the adhesive raw materials such as synthetic resin, natural resin, etc. are reacted and melted by heating.

The functional adhesive includes main components, hardeners, and additives. The main components may include a polyvinylacetate-based resin (PVAc), an ethylenevinylacetate-based resin (EVA), a melamin-based resin, a urea-based resin, a phenol-based resin, a urethane-based resin, an epoxy-based resin, an acryl-based resin, and a silica-based resin. The additives may include at least one of a filler such as CaCO₃, a solvent such as water, a stabilizer, a dispersing agent, an anti-foaming agent, a flatting agent, and other additives.

The hardener may be an isocyanate-based compound, and examples of the isocyanate compound include an aliphatic diisocyanate such as tetramethylene diisocyanate, trimethyl hexamethylene diisocyanate, 1,6-hexamethylene diisocyanate, or lysine diisocyanate; a hydrogen-added xylene diisocyanate such as 1,3-cyclohexyl diisocyanate, or 1,4-cyclohexyl diisocyanate; an alicyclic diisocyanate such as iso holoh diisocyanate), or tetra hydronaphthalene diisocyanate; an aromatic diisocynate such as 2,4-trilene diisocyanate, 2,6-trilene diisocyanate, m-phenylene diisocyanate, p-phenylene diisocyanate, diphenylmethane-4,4-diisocyanate, diphenylmethane-2,4-diisocyanate, diphenylmethane-2,2-diisocyanate, 3,3-dimethyl-4,4-biphenylene diisocyanate, or 1,5-naphthalene diisocyanante; an aroma-aliphatic diisocyanate such as xylene diisocyanate, or tetramethyl xylene diisocyanate; a triisocyanate such as 2,4,6-triisocyanate toluene, 2,4,4-triisocyanate diphenyl ether, triisocyanatephenyl methane, or triisocyanatephenylthiophosphite; a biuret-type polyisocyanate obtained from 3 moles of diisocyanate and 1 mole of water; an isocyanurate-type polyisocyanate derived from trimerized diiscyanate; a polymethylenepolyphenylpolyisocyanate and glycol additionally generated when diphenylmethane-4,4-diisocyanate is produced; a polyisocyanate such as an adduct-type polyisocyanate or isocyanate prepolymer which is obtained by adding polyisocyanate to triols, polyesterpolyols or polyetherpolyols; and the mixtures thereof. A liquid phase isocyanate that is relatively stable and low-volatile in a water solution may be used.

In the process of mixing, the natural plant raw materials in powder or liquid form are mixed with the flour.

In the process of dispersing, the natural plant in the powder or liquid form is added to the adhesive raw materials and the result is uniformly mixed. Here, the amount of the natural plant may be in the range of 1 to 10% by weight based on the total amount of the functional adhesive.

In the process of adjusting, the gloss or viscosity is adjusted according to the use of the functional adhesive.

In the process of inspection, the prepared functional adhesive is inspected to determine whether to the functional adhesive meets desired standards. The storage stability and safety of the functional adhesive can be measured.

### EXAMPLE

### Preparation of a Functional Adhesive

### Example 1

Green tea leaves were grinded by a grinder with high rotary power. When the grinding was completed, the particles discharged from the grinder were classified according to their particle size using air from an air blower, and a micropowder having a particle size of 20 to 150 μm was selected. Then, adhesive raw materials were reacted and melted by heating, wherein the adhesive raw materials included 90% by weight of a PVAc-based resin (MPU500 of Okong, Corp. or T-Glue102 of Tae kyung Chemicals, Co. Ltd.) and 10% by weight of an isocyanate-based hardener (MDI) as main components.

2% by weight of flour as a filler (2^{nd} or 3^{rd} grade for industrial use) was added to 96.5% by weight of the main components to adjust viscosity and 2.5% by weight of green tea leaf powder having 20% by weight of catechin was added to the sufficiently mixed result and dispersed. As a result, the functional adhesive according to an embodiment of the present invention was obtained.

As a result of analyzing green tea leaves using high performance liquid chromatography (HPLC) (Waters Alliance) and nuclear magnetic resonance (NMR) (Varian Unity Inova 500), it was determined that the amount of catechin in the green tea leaf ranged from 12% (green tea leaves gathered in March to April) to 20% (green tea leaves gathered in June to August). Green tea leaves having 20% catechin were used to prepare the functional adhesive in Example 1.

### Example 2

A functional adhesive was prepared in the same manner in Example 1, except that 2.5% by weight of green tea leaves having 12% by weight catechin was added to the adhesive composition.

### Example 3

A functional adhesive was prepared in the same manner in Example 1, except that 5% by weight of green tea leaves having 12% by weight catechin was added to the adhesive composition.

### Example 4

A functional adhesive was prepared in the same manner as in Example 1, except that 5% by weight of a green tea leaf powder having 20% by weight catechin was added to the adhesive composition.

### Example 5

A functional adhesive was prepared in the same manner as in Example 1, except that 10% by weight of a green tea leaf powder having 12% by weight catechin was added to the adhesive composition.

### Example 6

A functional adhesive was prepared in the same manner as in Example 1, except that 10% by weight of a green tea leaf powder having 20% by weight catechin was added to the adhesive composition.

### Comparative Example

A functional adhesive was prepared in the same manner as in Example 1, except that a powder or and extract of green tea leaves was not added.

### Experimental Example

### Measuring the Concentration and Diffusion Rate of TVOC of the Functional Adhesive

The diffused amount of TVOCs was measured under ISO6000-3 and ISO6000-6, and the diffused amount of HCHO was measured by a hazardous compound measuring method under KSF3111.

The results are shown in Table 3 below.

TABLE 3

| | TVOC[mg/m²hr] | HCHO[mg/m³] |
|---|---|---|
| Example 1 | 0.32 | 0.1 |
| Example 2 | 0.55 | 0.1 |
| Example 3 | 0.48 | Not detected |
| Example 4 | 0.23 | Not detected |
| Example 5 | 0.30 | Not detected |
| Example 6 | 0.19 | Not detected |
| Comparative Example | 3.65 | 0.2 to 0.6 |

As shown in Table 3, the diffused amount of TVOCs in Examples 1-6 was about one tenth of that of Comparative Example, and a very small amount of HCHO was detected or HCHO was not detected in Examples 1-6. Particularly, the hazardous compound removal effect can be considered to be excellent in Examples 3 to 6 since HCHO was not detected in these Examples.

According to the results shown in Table 3, the green tea leaves having high catechin content showed greater effectiveness than those having low catechin content. The TVOC levels should be less than 0.3 mg/m² hr to be classified as a first-grade adhesive in the domestic environment-friendly Human Body Model (HBM). The functional adhesives of Examples 1, 4, 5, and 6 can be classified into the first grade in view of an analytical error of 0.02 mg/m² hr.

### Measuring Storage Stability of the Adhesive and Pot Life

Storage stability was measured by checking deposits of a product packed for 5 months with the naked eye every month or by checking viscosity changes in the main components to which the green tea components are added.

The adhesive composition was mixed in a polyethylene (PE) bottle at room temperature, viscosity changes of the composition were measured every 20 minutes using a Brookfield Viscometer, and the time taken for the initial viscosity to double was measured to determine a pot life. The results are shown in Table 4.

Here, the term “pot life” indicates the time the prepared functional adhesive will stay in a liquid form that can be easily manipulated into other products.

TABLE 4

| | Storage stability | | Pot life |
|---|---|---|---|
| Example 1 | 3 to 4 | months | 1 hour and 30 minutes |
| Example 2 | 3 to 4 | months | 1 hour and 30 minutes |
| Example 3 | 4 | months | 1 hour and 34 minutes |
| Example 4 | 4 | months | 1 hour and 35 minutes |
| Example 5 | 4 | months or more | 1 hour and 39 minutes |
| Example 6 | 4 | months or more | 1 hour and 39 minutes |
| Comparative Example | 2 to 3 | months | 1 hour |

As shown in Table 4, the storage stability and pot life of the functional adhesive of Examples 1-6 according to embodiments of the present invention are superior to those of the Comparative Example.

### INDUSTRIAL APPLICABILITY

The functional adhesive of the present invention can reduce VOCs and HCHO of a functional adhesive, and also reduce VOCs of products to which the functional adhesive is applied.

1. A functional adhesive comprising a flavonoid-based compound, a polyphenol-based compound, a steroid-based compound or a mixture thereof, wherein the flavonoid-based compound, the polyphenol-based compound, or the steroid-based compound has a molecular weight of 250 to 1000 grams/mole.

2. The functional adhesive of claim 1, wherein the flavonoid-based compound or the polyphenol-based compound contains at least one compound selected from the group consisting of anthoxanthin, anthocyanin, catechin, tannin, and caffeine.

3. The functional adhesive of claim 1, wherein the steroid-based compound contains at least one compound selected from the group consisting of cholesterol, saponin, and β-carotene.

4. The functional adhesive of claim 1, wherein the amount of the flavonoid-based compound, the polyphenol-based compound or the steroid-based compound is in the range of 0.01 to 2% by weight based on the total amount of the functional adhesive.

5. The functional adhesive of clam 1, wherein the amount of the flavonoid-based compound, the polyphenol-based compound or the steroid-based compound is in the range of 0.5 to 2% by weight based on the total amount of the functional adhesive.

6. The functional adhesive of claim 1, wherein the flavonoid-based compound or the steroid-based compound is obtained from natural plants.

7. The functional adhesive of claim 6, wherein the natural plants include at least one plant selected from the group consisting of an oak tree, a mangrove tree, a mahogany tree, an acacia tree, a persimmon tree, a chestnut shell, a peach, an apple, a grape, a persimmon, green tea, black tea, oolong tea, jasmine tea, bohea tea, tieguanyin tea, Bongro tea, Youbi tea, Soosun tea, Ogo tea, white tea, blue tea, powdered green tea, cassia tea, tobacco leaf, angelica keiskei, kale, coffee, and barley.

8. The functional adhesive of claim 6, wherein the flavonoid-based compound, the polyphenol-based compound or the steroid-based compound is in the form of dried powder, a suspension of a dried powder, flakes, an extract, or a dried powder of the extract of the natural plant.

9. The functional adhesive of claim 8, wherein the particle size of the dried powder and the thickness of the flakes of the natural plant are in the range of 20 to 150 μm.

10. The functional adhesive of claim 8, wherein the amount of the dried powder and the flake of the natural plant is in the range of 1 to 10% by weight based on the total amount of the functional adhesive.

11. The functional adhesive of claim 8, wherein the solvent used for the extract or the suspension of the dried powder of the natural plant includes at least one solvent selected from the group consisting of water, alcohol, oil, and resin.

12. The functional adhesive of claim 1 comprising main components and additives,
wherein the main components comprise at least one resin selected from the group consisting of a polyvinylacetate-based resin, an ethylenevinylacetate-based resin, a melamin-based resin, a urea-based resin, a phenol-based resin, a urethane-based resin, an epoxy-based resin, an acryl-based resin, a silica-based resin, and a hardener, and
the additives comprise at least one additive selected from the group consisting of a filler, a stabilizer, an anti-foaming agent, a dispersing agent, and a flatting agent.

13. The functional adhesive of claim 1, wherein the main components comprise 90% by weight of a polyvinylacetate-based resin and 10% by weight of an isocyanate-based hardener (MDI), the filler is flour, and the flavonoid-based compound, the polyphenol-based compound, the steroid-based compound or the mixture thereof is comprised in a green tea leaf powder, and the functional adhesive comprises 81.8 to 96.8% by weight of the main components, 0.7 to 8.2% by weight of the flour, and 2.5 to 10% by weight of the green tea leaf powder.

14. The functional adhesive of claim 1 used to provide an adhesive force to the surface of at least one construction material selected from the group consisting of a film, a door, a window, a chair, a desk, a floor, wall paper, a material for a ceiling, a material for a closet and a flooring material.

15. A construction material to which the functional adhesive of claim 1 is applied.

16. A method of preparing a functional adhesive comprising:
grinding a dried plant and selecting a micropowder having a particle size of 20 to 150 μm,
reacting and melting adhesive raw materials including main component resins by heating;
sufficiently mixing the micropowder with a filler; and
dispersing the mixed powder in the adhesive raw materials such that the amount of the mixed powder is 1 to 10% by weight based on the total amount of the functional adhesive.

17. The method of claim 16, wherein a natural plant extract, a dried powder of an extract of a natural plant or a suspension of the micropowder is added to the functional adhesive raw materials instead of the micropowder.

18. The method of claim 16, wherein the natural plant includes at least one plant selected from the group consisting of an oak tree, a mangrove tree, a mahogany tree, an acacia tree, a persimmon tree, a chestnut shell, a peach, an apple, a grape, a persimmon, green tea, black tea, oolong tea, jasmine tea, bohea tea, tieguanyin tea, Bongro tea, Youbi tea, Soosun tea, Ogo tea, white tea, blue tea, powdered green tea, cassia tea, tobacco leaf, angelica keiskei, kale, coffee, and barley.
